(19) United States
(12) Patent Application Publication
(10) Pub. No.: US 2017/0106755 A1
(43) Pub. Date: Apr. 20, 2017

(54) VEHICLE CONTROL APPARATUS

(71) Applicant: TOYOTA JIDOSHA KABUSHIKI KAISHA, Toyota-shi (JP)

(72) Inventor: Masatoshi NAKATSU, Susono-shi (JP)

(73) Assignee: TOYOTA JIDOSHA KABUSHIKI KAISHA, Toyota-shi (JP)

(21) Appl. No.: 15/293,755

(22) Filed: Oct. 14, 2016

(30) Foreign Application Priority Data
Oct. 19, 2015 (JP) 2015-205679

(51) Int. Cl. B60L 7/26; B60T 8/24

(52) U.S. Cl. CPC B60L 7/26; B60T 8/246; B60T 2270/604

(57) ABSTRACT

A vehicle control apparatus includes a controller configured to change a ratio between a regenerative braking force and a frictional braking force, in a specific wheel among wheels, such that the ratio in the specific wheel differs from the ratio between the regenerative braking force and the frictional braking force in each of the other wheels, when a command to generate the require braking force is issued and a vehicle motion control is executed.

### INCORPORATION BY REFERENCE

The disclosure of Japanese Patent Application No. 2015-205679 filed on Oct. 19, 2015 including the specification, drawings and abstract is incorporated herein by reference in its entirety.

### BACKGROUND

1. Field of the Disclosure

The disclosure relates to a vehicle control apparatus.

2. Description of Related Art

In-wheel motor vehicles are known. In an in-wheel motor vehicle, a motor is disposed inside or near each of the wheels of the vehicle, and a driving force and a braking force to be applied to each wheel are controlled independently from driving forces and braking forces to be applied to the other wheels. For example, Japanese Patent Application Publication No. 2012-086712 (JP 2012-086712 A) describes a vehicle control apparatus for an in-wheel motor vehicle. In the in-wheel motor vehicle, the vehicle control apparatus controls driving forces and braking forces to be applied to the drive wheels, thereby executing control (vehicle motion control) of vehicle motions (e.g. a yaw motion and a roll motion) generated in a vehicle body.

In the in-wheel motor vehicle as described in JP 2012-086712 A, in addition to the above-described vehicle motion control, regeneration-friction cooperative brake control is executed. In the regeneration-friction cooperative brake control executed at the time of braking of the vehicle, a regenerative braking force obtained by using each in-wheel motor and a frictional braking force obtained by using each hydraulic brake mechanism are cooperatively controlled to generate a desired braking force.

### SUMMARY

However, in the vehicle control apparatus described in JP 2012-086712 A, a balance between a motor force of the in-wheel motor to be used in the regeneration-friction cooperative brake control and a motor force of the in-wheel motor to be used in the vehicle motion control is not taken into account. Therefore, for example, when the vehicle motion control is executed at the time of braking of the vehicle, the ratio of a regenerative braking force to the entire braking force in the regeneration-friction cooperative brake control may be so high that a used motor force exceeds the upper limit of a control range for the in-wheel motor, or the ratio of a regenerative braking force to the entire braking force in the regeneration-friction cooperative brake control may be so low that desired regenerative electric power cannot be obtained. The “motor force” indicates a driving force and a regenerative braking force obtained by using the in-wheel motor.

The disclosure provides a vehicle control apparatus configured to efficiently execute regeneration-friction cooperative brake control and vehicle motion control at the same time.

An aspect of the disclosure relates to a vehicle control apparatus including: braking-driving force generation mechanisms provided at respective wheels of a vehicle, each of the braking-driving force generation mechanisms configured to generate a driving force to be applied to a corresponding one of the wheels or a regenerative braking force to be applied to the corresponding one of the wheels; friction braking mechanisms provided at the respective wheels, each of the friction braking mechanisms configured to apply a frictional braking force to a corresponding one of the wheels; and a controller configured to control the braking-driving force generation mechanisms and the friction braking mechanisms. The controller includes: a required braking force calculation unit configured to calculate a required braking force; a braking force ratio calculation unit configured to calculate a ratio between the regenerative braking force and the frictional braking force in the required braking force to be applied to each of the wheels, based on the required braking force; a vehicle motion control force calculation unit configured to calculate a vehicle motion control force for causing each of the braking-driving force generation mechanisms to generate the driving force or the regenerative braking force, the vehicle motion control force being a control force for executing vehicle motion control for controlling a motion of the vehicle; and a braking force ratio changing unit configured to change the ratio between the regenerative braking force and the frictional braking force in a specific wheel among the wheels, such that the ratio in the specific wheel differs from the ratio between the regenerative braking force and the frictional braking force in each of the other wheels, when a command to generate the require braking force is issued and the vehicle motion control is executed.

According to the above aspect, the vehicle control apparatus can efficiently execute the regeneration-friction cooperative brake control and the vehicle motion control at the same time, by changing the ratio between the regenerative braking force and the frictional braking force when executing the vehicle motion control at the time of braking of the vehicle.

In the vehicle control apparatus according to the above aspect, the braking force ratio changing unit may be configured to decrease the ratio of the regenerative braking force to the required braking force to be applied to at least one of the wheels on a turning inner side when the vehicle is making a turn.

According to the above aspect, the vehicle control apparatus can decrease the used motor force of the in-wheel motor from exceeding the upper limit of the control range, by decreasing the ratio of the regenerative braking force to the required braking force, regarding the ratio between the regenerative braking force and the frictional braking force in the wheel on the turning inner side in which the used motor force is likely to exceed the upper limit of the control range for the in-wheel motor.

In the vehicle control apparatus according to the above aspect, the braking force ratio changing unit may be configured to make a rate or amount of a change in the ratio for the front wheel on the turning inner side greater than a rate or amount of a change in the ratio for the rear wheel on the turning inner side when decreasing the ratio of the regenerative braking force to the required braking force to be applied to at least one of the wheels on the turning inner side.

According to the above aspect, the vehicle control apparatus can decrease the used motor force of the in-wheel motor from exceeding the upper limit of the control range, by increasing the rate or amount of change in the ratio of the regenerative braking force to the required braking force to be applied to the front wheel on the turning inner side in which the used motor force of the in-wheel motor is most likely to exceed the upper limit of the control range.

In the vehicle control apparatus according to the above aspect, the braking force ratio changing unit may be configured to decrease the ratio of the frictional braking force to the required braking force to be applied to at least one of the wheels on a turning outer side when the vehicle is making a turn.

According to the above aspect, the vehicle control apparatus can increase the regenerative braking force applied to at least one of the wheels on the turning outer side and decrease the frictional braking force applied to at least one of the wheels on the turning outer side. Thus, it is possible to increase the amount of electric power to be charged into the battery and reduce a frictional loss.

In the vehicle control apparatus according to the above aspect, the braking force ratio changing unit may be configured to make a rate or amount of a change in the ratio for the front wheel on the turning outer side greater than a rate or amount of a change in the ratio for the rear wheel on the turning outer side when decreasing the ratio of the frictional braking force to the required braking force to be applied to at least one of the wheels on the turning outer side.

According to the above aspect, the vehicle control apparatus can increase the regenerative electric power and reduce the frictional loss, by increasing the rate or amount of change in the ratio of the frictional braking force, in the front wheel on the turning outer side in which there is plenty of room in the control range for the in-wheel motor.

According to the above aspect, the required braking force calculation unit may be configured to calculate the required braking force based on a braking operation performed by a driver.

According to the above aspect, each of the braking-driving force generation mechanisms may generate the driving force to be applied to a corresponding one of the wheels or the regenerative braking force to be applied to the corresponding one of the wheels, independently from the braking-driving force generation mechanisms of the other wheels.

According to the above aspect, each of the braking-driving force generation mechanisms may be a motor that generates the driving force to be applied to a corresponding one of the wheels or the regenerative braking force to be applied to the corresponding one of the wheels.

With the vehicle control apparatus according to the aspect of the disclosure, it is possible to reliably execute the vehicle motion control at the time of braking of the vehicle by changing the ratio of the regenerative braking force to the required braking force, regarding the ratio between the regenerative braking force and the frictional braking force in the required braking force to be applied to each wheel, thereby efficiently execute the regeneration-friction cooperative brake control and the vehicle motion control at the same time.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram schematically illustrating the configuration of a vehicle including a vehicle control apparatus according to embodiments of the disclosure;

FIG. 2 is a block diagram schematically illustrating the configuration of an electronic control unit (ECU) of the vehicle control apparatus according to the embodiments of the disclosure;

FIG. 3 is a diagram illustrating forces acting on each wheel in the vehicle motion control executed by the vehicle control apparatus at the time of braking of the vehicle;

FIG. 4 is a flowchart illustrating the vehicle motion control executed, at the time of braking of the vehicle, by the vehicle control apparatus according to a first embodiment of the disclosure;

FIG. 5 is a diagram illustrating forces acting on each wheel in the vehicle motion control executed, at the time of braking of the vehicle, by the vehicle control apparatus according to the first embodiment of the disclosure;

FIG. 6 is a diagram illustrating forces acting on each wheel in the vehicle motion control executed, at the time of braking of the vehicle, by the vehicle control apparatus according to a third embodiment of the disclosure;

FIG. 7 is a diagram illustrating forces acting on each wheel in the vehicle motion control executed, at the time of braking of the vehicle, by the vehicle control apparatus according to a fourth embodiment of the disclosure;

FIG. 8 is a diagram illustrating forces acting on each wheel in the vehicle motion control executed, at the time of braking of the vehicle, by the vehicle control apparatus according to a fifth embodiment of the disclosure; and

FIG. 9 is a diagram illustrating forces acting on each wheel in the vehicle motion control executed, at the time of braking of the vehicle, by the vehicle control apparatus according to a sixth embodiment of the disclosure.

### DETAILED DESCRIPTION OF EMBODIMENTS

Hereinafter, vehicle control apparatuses according to example embodiments of the disclosure will be described with reference to the accompanying drawings. The disclosure is not limited to the following embodiments. Further, some of the elements in the following embodiments may be replaced with elements that are easily conceived of by a person skilled in the art or elements that are substantially equivalent to those in the following embodiments.

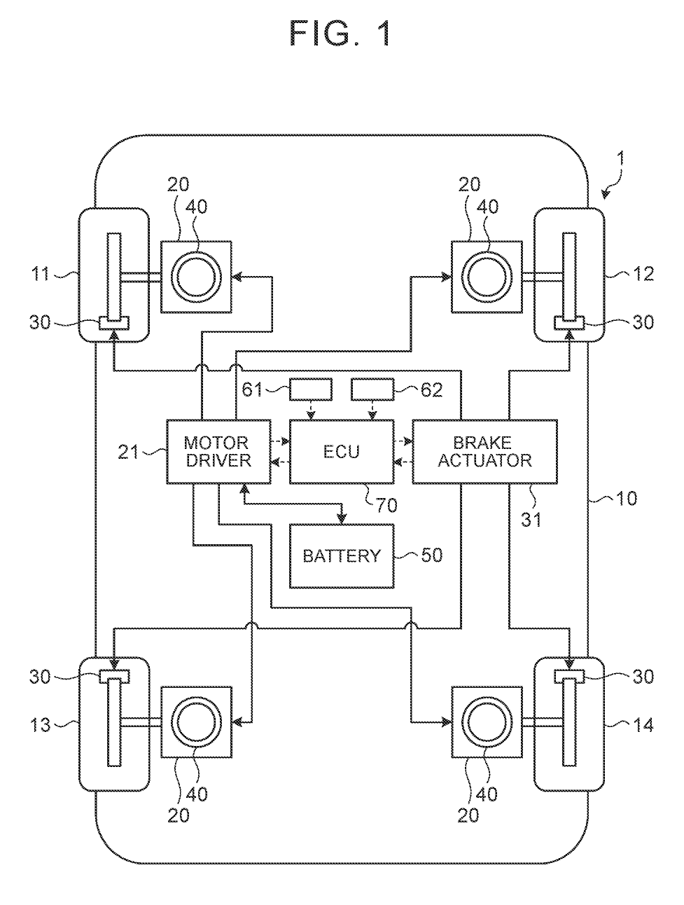

First, a first embodiment will be described. A vehicle control apparatus is mounted in an in-wheel motor vehicle 1. The vehicle 1 includes wheels 11, 12, 13, 14, four in-wheel motors 20, which may function as braking-driving force generation mechanisms, a motor driver 21, four brake mechanisms 30, a brake actuator 31, suspension mechanisms 40, a battery 50, an operation state detection apparatus 61, a vehicle state detection apparatus 62, and an electronic control unit (ECU) 70, which may function as a controller, as illustrated in FIG. 1. The vehicle control apparatus includes at least the in-wheel motors 20, the brake mechanisms 30, and the ECU 70.

The wheels 11, 12, 13, 14 are respectively connected to a vehicle body 10 via the suspension mechanisms 40 that are independent from each other, as illustrated in

FIG. 1. The in-wheel motors 20 are respectively provided in the wheels 11, 12, 13, 14.

The in-wheel motors 20 are respectively provided in the wheels 11, 12, 13, 14. Each of the in-wheel motors 20 individually generates a driving force or a braking force (hereinafter referred to as “regenerative braking force”) to be applied to a corresponding one of the wheels 11, 12, 13, 14, independently from the other in-wheel motors 20. Each of the in-wheel motors 20 is, for example, a brushless motor, and is connected to the battery 50, which is an electric power storage device, via the motor driver 21.

The motor driver 21 is, for example, an inverter. The motor driver 21 converts direct-current (DC) power supplied from the battery 50 into alternating-current (AC) power, and then supplies the AC power to each in-wheel motor 20. Thus, the in-wheel motors 20 are subjected to drive control, thereby applying driving forces to the wheels 11, 12, 13, 14. An operation of supplying electric power to the in-wheel motors 20 to cause the in-wheel motors 20 to generate driving torque will be referred to as “motoring”.

The in-wheel motors 20 function also as electric power generators, so that the electric power generated by using rotational energy of the wheels 11, 12, 13, 14 is charged into the battery 50 via the motor driver 21. Due to the braking torque generated through the power generation by the in-wheel motors 20, a regenerative braking force is applied to each of the wheels 11, 12, 13, 14.

The brake mechanisms 30, which may function as friction brake mechanisms, are respectively provided in the wheels 11, 12, 13, 14. The brake mechanisms 30 are configured to apply frictional braking forces to the wheels 11, 12, 13, 14. Each of the brake mechanisms 30 is, for example, a disc brake, and is connected to the brake actuator 31. The brake actuator 31 causes each brake mechanism 30 to generate a frictional braking force, by using hydraulic pressure from a master cylinder (not illustrated).

Each suspension mechanism 40 may be, for example, a strut suspension including a strut incorporating a shock absorber, a coil spring, and a suspension arm, or may be a double wishbone suspension including a coil spring, a shock absorber, and upper and lower suspension arms.

The operation state detection apparatus 61 includes, for example, a steering angle sensor that detects an operation amount (a steering angle) of a steering wheel achieved by a driver, an accelerator sensor that detects an operation amount (e.g. a depression amount, a depression angle, or a depression pressure) of an accelerator pedal achieved by the driver, a throttle sensor that detects an opening degree of a throttle valve provided for an engine and actuated in response to an operation of the accelerator pedal, and a brake sensor that detects an operation amount (e.g. a depression amount, a depression angle, or a depression pressure) of a brake pedal achieved by the driver.

The vehicle state detection apparatus 62 includes, for example, a sprung mass vertical acceleration sensor that detects a vertical acceleration in the vertical direction of the vehicle body 10 (sprung mass), a lateral acceleration sensor that detects a lateral acceleration in the lateral direction of the vehicle body 10, a vehicle speed sensor that detects a vehicle speed of the vehicle body 10, a yaw rate sensor that detects a yaw rate generated in the vehicle body 10, a pitch rate sensor that detects a pitch rate generated in the vehicle body 10, and a roll rate sensor that detects a roll rate generated in the vehicle body 10.

The ECU 70 includes, as a main component, a microcomputer including, for example, a central processing unit (CPU), a read-only memory (ROM), and a random-access memory (RAM). The ECU 70 executes various programs. Signals from various sensors constituting the operation state detection apparatus 61 and the vehicle state detection apparatus 62 and a signal from the motor driver 21 are input into the ECU 70, as illustrated in FIG. 1. Thus, the ECU 70 is able to recognize and control a travel state of the vehicle 1 and a vehicle motion state of the vehicle 1.

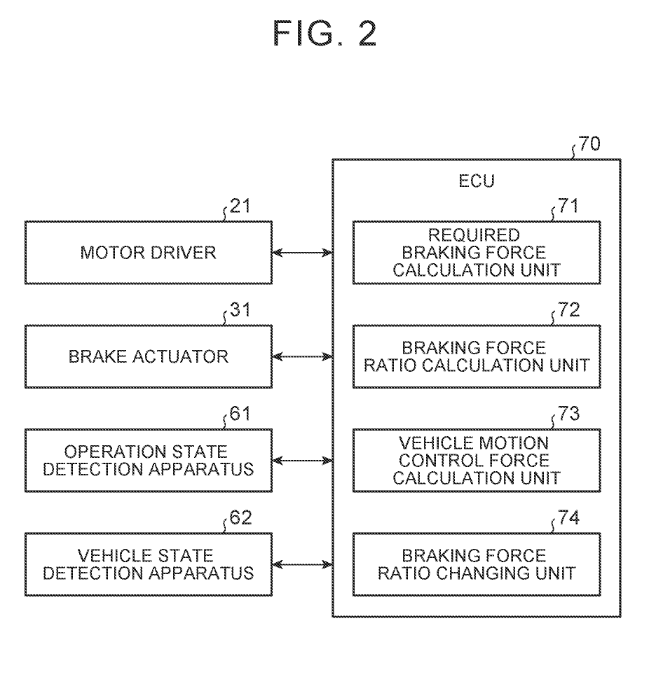

The ECU 70 includes a required braking force calculation unit 71 (an example of a required braking force calculation unit), a braking force ratio calculation unit 72 (an example of a braking force ratio calculation unit), a vehicle motion control force calculation unit 73 (an example of a vehicle motion control force calculation unit), and a braking force ratio changing unit 74 (an example of a braking force ratio changing unit), as illustrated in FIG. 2. The configurations of these units will be described later. The ECU 70 executes, through calculation, processes (described later) that are executed by the required braking force calculation unit 71, the braking force ratio calculation unit 72, the vehicle motion control force calculation unit 73, and the braking force ratio changing unit 74.

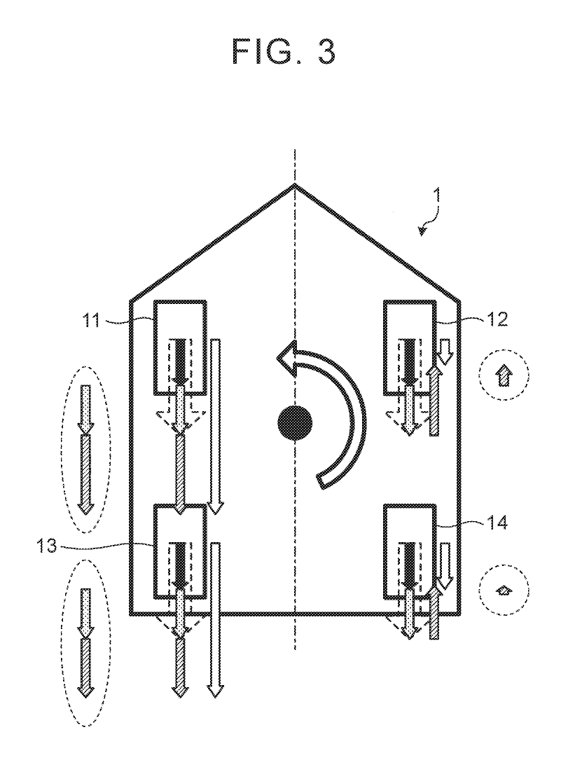

Hereinafter, regeneration-friction cooperative brake control executed in the vehicle 1 will be described with reference to FIG. 3. For example, when the driver performs a braking operation by depressing the brake pedal, the operation state detection apparatus 61 detects an amount of the operation, and the ECU 70 calculates, for each of the wheels 11, 12, 13, 14, a required braking force that is required by the driver, based on the operation amount (refer to each dashed arrow in FIG. 3).

Then, the ECU 70 divides the required braking force to be applied to each of the wheels 11, 12, 13, 14, into a regenerative braking force to be obtained by using the in-wheel motor 20 (refer to each arrow with a dot pattern in FIG. 3) and a frictional braking force to be obtained by using the brake mechanism 30 (refer to each filled-in arrow in FIG. 3). In FIG. 3, for convenience of description, the ratio between the regenerative braking force and the frictional braking force to be applied to each of the wheels 11, 12, 13, 14 is illustrated as the same ratio, but the ratio between the regenerative braking force and the frictional braking force to be applied to each of the wheels 11, 12, 13, 14 is actually calculated based on, for example, the magnitude of the required braking force, and the longitudinal acceleration (i.e., the acceleration in the front-rear direction of the vehicle 1).

Then, the ECU 70 controls each in-wheel motor 20 via the motor driver 21 to generate a regenerative braking force at the calculated ratio. At the same time, the ECU 70 controls the brake mechanisms 30 via the brake actuator 31 to generate a frictional braking force at the calculated ratio. In this way, in the regeneration-friction cooperative brake control, the regenerative braking force obtained by using each in-wheel motor 20 and the frictional braking force obtained by using each brake mechanism 30 are cooperatively controlled to generate the required braking force that is required by the driver.

Next, the vehicle motion control executed in the vehicle 1 will be described with reference to FIG. 3. Hereinafter, a case where a yaw motion and a roll motion that act on the vehicle body 10 are controlled when the vehicle 1 is turning to the left will be described.

The vehicle motion control is executed by using the in-wheel motors 20 provided in the wheels 11, 12, 13, 14. That is, when vehicle motions such as a yaw motion and a roll motion are generated during braking of the vehicle 1, the ECU 70 controls each of the in-wheel motors 20 of the wheels 11, 12, 13, 14 independently from the other in-wheel motors 20 to generate a driving force or a braking force to be applied to each of the wheels 11, 12, 13, 14, thereby controlling the vehicle motions.

For example, when the vehicle 1 is turning to the left in FIG. 3, the ECU 70 applies a regenerative control force (refer to each downward hatched arrow in FIG. 3) to each of the in-wheel motors 20 provided in the wheels 11, 13 on the turning inner side. Thus, a regenerative braking force is generated in each of the wheels 11, 13 on the turning inner side. The “regenerative control force” indicates a control force (a control command value) for a regeneration operation of the in-wheel motors 20. By applying the regenerative control force to each in-wheel motor 20, a regenerative braking force corresponding to the regenerative control force is generated in the corresponding wheel. Further, the regenerative control force and a motoring control force (described later) is collectively defined herein as “vehicle motion control force”.

The regenerative control force herein is a control command value for generating a regenerative braking force to be applied to each of the wheels 11, 12, 13, 14 and, strictly speaking, the regenerative control force is different from a regenerative braking force. However, in FIG. 3, for convenience of description, each downward hatched arrow is used to indicate both “regenerative control force” as a control command value that is given from the ECU 70 to each in-wheel motor 20 and “regenerative braking force” as a force generated in each of the wheels 11, 13 due to the regenerative control force.

Further, the ECU 70 applies a motoring control force (refer to each upward hatched arrow in FIG. 3) to each of the in-wheel motors 20 provided in the wheels 12, 14 on the turning outer side, as illustrated in FIG. 3. Thus, a driving force is generated in each of the wheels 12, 14 on the turning outer side. The “motoring control force” indicates a control force (a control command value) for a powering operation of the in-wheel motors 20. By applying the motoring control force to each in-wheel motor 20, a driving force corresponding to the motoring control force is generated in the corresponding wheel.

The motoring control force herein is a control command value for generating a driving force to be applied to each of the wheels 11, 12, 13, 14 and, strictly speaking, the motoring control force is different from a driving force. However, in FIG.

3, for convenience of description, each upward hatched arrow is used to indicate both “motoring control force” as a control command value that is given from the ECU 70 to each in-wheel motor 20 and “driving force” as a force generated in each of the wheels 12, 14 due to the motoring control force. “Resultant force” indicated by each hollow arrow in FIG. 3 indicates the resultant (vector sum) of a required braking force (refer to each dashed arrow in FIG. 3) and a regenerative braking force corresponding to a regenerative control force or a driving force corresponding to a motoring control force.

Thus, when a regenerative braking force or a driving force is generated in each of the wheels 11, 12, 13, 14 by the corresponding in-wheel motor 20, a vertically downward force (sinking force) acts on the front wheel 11 on the turning inner side, a vertically upward force (floating force) acts on the front wheel 12 on the turning outer side, a vertically downward force acts on the rear wheel 13 on the turning inner side, and a vertically upward force acts on the wheel 14 on the turning outer side. Generation of such vertical forces is due to the positional relationship between the instantaneous centers of rotations of the suspension mechanisms 40 on the front wheels 11, 12 side and the instantaneous centers of rotations of the suspension mechanisms 40 on the rear wheels 13, 14 side (see, for example, Japanese Patent Application Publication No. 2015-80323 (JP 2015-80323 A) for details).

When the downward force acts on the front wheel 11, the upward force acts on the front wheel 12, the downward force acts on the rear wheel 13, and the upward force acts on the rear wheel 14, two roll moments in different directions are generated respectively on the front wheels 11, 12 side and the rear wheels 13, 14 side. Therefore, the ECU 70 controls the roll motion by adjusting the magnitudes of the motoring control forces and the regenerative control forces applied to the in-wheel motors 20 of the wheels 11, 12, 13, 14 such that the two roll moments, that is, the roll moment on the front wheels 11, 12 side and the roll moment on the rear wheels 13, 14 side become equal to each other (the roll moments are balanced).

In a conventional vehicle control apparatus, a balance between a motor force of the in-wheel motors 20 used in the regeneration-friction cooperative brake control and a motor force of the in-wheel motors 20 used in the vehicle motion control is not taken into account. Therefore, the following problems may occur.

When the regeneration-friction cooperative brake control and the vehicle motion control are executed at the same time, a motor force used in each in-wheel motor 20 (used motor force) is a resultant force of a regenerative braking force in the regeneration-friction cooperative brake control (refer to each arrow with a dot pattern in FIG. 3) and a regenerative braking force corresponding to a regenerative control force in the vehicle motion control (or a driving force corresponding to a motoring control force) (refer to each hatched arrow in FIG. 3), as indicated by each dashed circle in FIG. 3.

As illustrated in FIG. 3, on the turning outer side, the direction of the regenerative braking force in the regeneration-friction cooperative brake control and the direction of the driving force corresponding to the motoring control force in the vehicle motion control are opposite to each other. Thus, the regenerative braking force and the driving force cancel out each other, and the used motor force becomes small as a whole. On the other hand, on the turning inner side, the direction of the regenerative braking force in the regeneration-friction cooperative brake control and the direction of the regenerative braking force corresponding to the regenerative control force in the vehicle motion control coincide with each other. Thus, the regenerative braking forces are added together, and the used motor force becomes large as a whole. There is an upper limit to the driving force or the regenerative braking force that can be generated by each in-wheel motor 20. Thus, on the turning inner side, the used motor force may exceed the upper limit of the used motor force in each in-wheel motor 20, that is, the used motor force may exceed the upper limit of a control range for the in-wheel motor 20.

In view of this, the vehicle control apparatus according to the present embodiment is configured to avoid the above-described problem by changing the ratio of a regenerative braking force to a required braking force in the regeneration-friction cooperative brake control when the vehicle control apparatus executes the vehicle motion control during braking of the vehicle 1. Hereinafter, the control executed by the vehicle control apparatus according to the present embodiment will be described with reference to FIGS. 2 to 5.

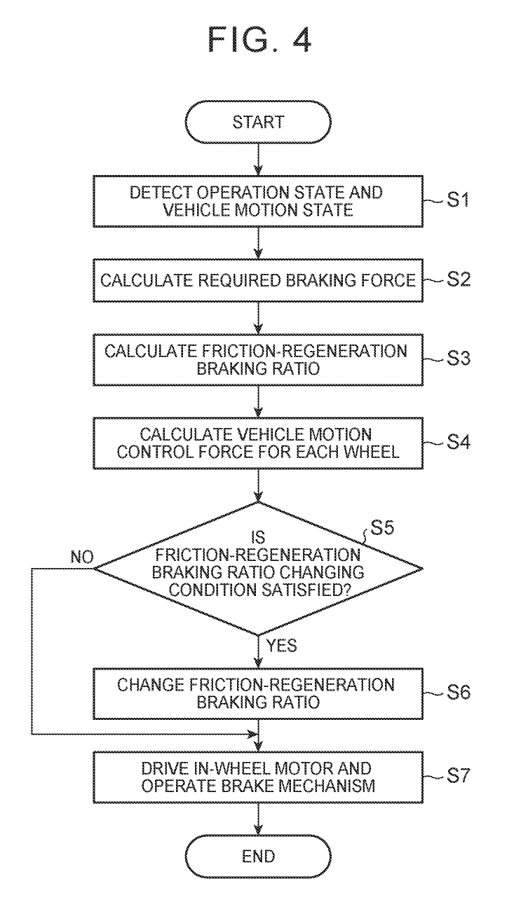

The vehicle control apparatus according to the present embodiment first detects an operation state achieved by the driver, by using the operation state detection apparatus 61, and detects a vehicle state by using the vehicle state detection apparatus 62, as illustrated in FIG. 4 (step S1). Specifically, the ECU 70 acquires, for example, a braking operation amount and a steering operation amount based on sensor values from the operation state detection apparatus 61, and acquires a vehicle speed and a motion state amount indicating the degree of a motion state of the vehicle body 10 (e.g. a yaw motion, a roll motion, a pitch motion, and a heave motion) based on sensor values from the vehicle state detection apparatus 62.

Then, the required braking force calculation unit 71 of the ECU 70 calculates a required braking force required by the driver, based on a braking operation performed by the driver, that is, based on the braking operation amount acquired from the operation state detection apparatus 61 (step S2). The ECU 70 stores, in advance, association data, such as a map, for determining the required braking force based on the braking operation amount. The required braking force calculation unit 71 calculates the required braking force to be applied to each of the wheels 11, 12, 13, 14 based on the association data, as indicated by the dashed arrows in FIG. 3.

Then, the braking force ratio calculation unit 72 of the ECU 70 calculates a friction-regeneration braking ratio for each of the wheels 11, 12, 13, 14 (step S3). That is, the braking force ratio calculation unit 72 calculates, based on, for example, the magnitude of the required braking force, a ratio between a regenerative braking force (refer to each arrow with a dot pattern in FIG. 3) and a frictional braking force (refer to each filled-in arrow in FIG. 3) in the required braking force (refer to each dashed arrow in FIG. 3) to be applied to each of the wheels 11, 12, 13, 14, as illustrated in FIG. 3. The “friction-regeneration braking ratio” indicates the ratio between the frictional braking force and the regenerative braking force to be applied to each of the wheels 11, 12, 13, 14 in the regeneration-friction cooperative brake control.

Then, the vehicle motion control force calculation unit 73 of the ECU 70 calculates a vehicle motion control force for each of the wheels 11, 12, 13, 14 (step S4). That is, the vehicle motion control force calculation unit 73 calculates a vehicle motion control force (a motoring control force or a regenerative control force). The vehicle motion control force is a control force for executing the vehicle motion control for controlling the vehicle motions including a yaw motion and a roll motion of the vehicle 1 by using the in-wheel motor 20. The vehicle motion control force is used to generate a driving force or a regenerative braking force in each of the wheels 11, 12, 13, 14 corresponding to the in-wheel motors 20.

Then, the ECU 70 determines whether a friction-regeneration braking ratio changing condition is satisfied (step S5). The friction-regeneration braking ratio changing condition is satisfied when a braking operation is performed by the driver and the vehicle motion control including yaw motion control and roll motion control needs to be executed. Whether the braking operation is performed by the driver can be detected by the operation state detection apparatus 61. Further, whether the vehicle motion control needs to be executed is determined based on whether the deviations between an ideal yaw rate and an ideal roll rate set based on, for example, a steering angle and a vehicle speed, and a yaw rate and a roll rate detected respectively by a yaw rate sensor and a roll rate sensor exceed prescribed allowable values.

When the friction-regeneration braking ratio changing condition is not satisfied (No in step S5), the ECU 70 drives each in-wheel motor 20 and operates each brake mechanism 30 based on the friction-regeneration braking ratio calculated by the braking force ratio calculation unit 72 (step S7). That is, in this case, the regeneration-friction cooperative brake control is executed based on the friction-regeneration braking ratios illustrated in FIG. 3.

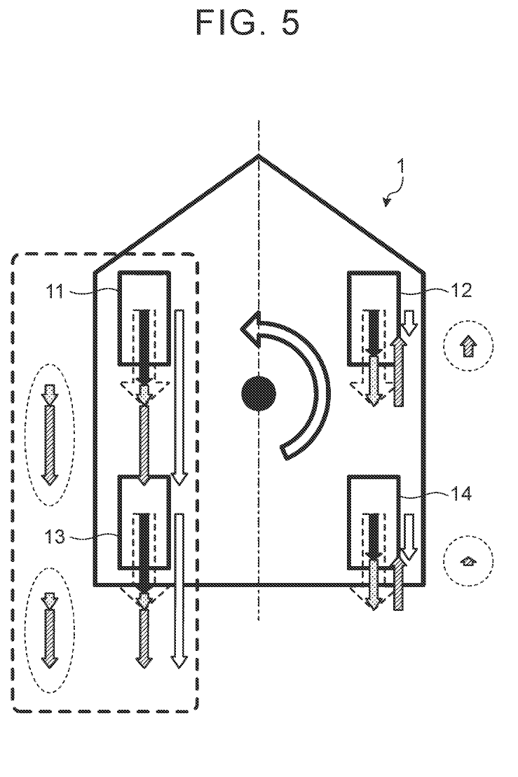

On the other hand, when the friction-regeneration braking ratio changing condition is satisfied (Yes in step S5), the braking force ratio changing unit 74 of the ECU 70 changes the friction-regeneration braking ratio (step S6). That is, when a braking operation is performed by the driver and the vehicle motion control is executed as illustrated in FIG. 5, the braking force ratio changing unit 74 changes the ratio between the regenerative braking force and the frictional braking force, which is calculated by the braking force ratio calculation unit 72, from the ratio illustrated in FIG. 3.

In the conventional vehicle control apparatus, when the regeneration-friction cooperative brake control and the vehicle motion control are executed at the same time, the used motor force may exceed the upper limit of the control range for the in-wheel motor 20 on the turning inner side. In view of this, regarding the ratio between the regenerative braking force and the frictional braking force in the required braking force to be applied to each of the wheels 11, 13, which is calculated by the braking force ratio calculation unit 72 (see FIG. 3), the braking force ratio changing unit 74 decreases the ratio of the regenerative braking force to the required braking force and increases the ratio of the frictional braking force to the required braking force, as illustrated in detail in FIG. 5.

The braking force ratio changing unit 74 decreases the regenerative braking force, for example, to the extent that the used motor force (refer to each dashed circle in FIG. 5) used in each of the in-wheel motors 20 provided in the wheels 11, 13 on the turning inner side does not exceed the upper limit of the control range for the in-wheel motor 20. The used motor force is a resultant force of the regenerative braking force based on the friction-regeneration braking ratio and the regenerative braking force corresponding to the regenerative control force in the vehicle motion control.

Then, the ECU 70 drives each in-wheel motor 20 and operates each brake mechanism 30 based on the friction-regeneration braking ratio changed by the braking force ratio changing unit 74 (step S7). That is, in this case, the regeneration-friction cooperative brake control is executed based on the friction-regeneration braking ratios illustrated in FIG. 5.

Thus, the vehicle control apparatus according to the present embodiment decreases the ratio of the regenerative braking force to the required braking force to be applied to each of the wheels 11, 13 on the turning inner side, in which the used motor force is likely to exceed the upper limit of the control range for the in-wheel motor 20, regarding the ratio between the regenerative braking force and the frictional braking force in the required braking force to be applied to each of the wheels 11, 13 on the turning inner side, which is calculated by the braking force ratio calculation unit 72. That is, the vehicle control apparatus calculates the required braking force based on a braking operation performed by the driver, calculates the ratio between the regenerative braking force and the frictional braking force in the required braking force, and decreases the ratio of the regenerative braking force to the required braking force to be applied to each of the wheels 11, 13 that are controlled based on the calculated ratio. Thus, it is possible to prevent the used motor force of each of the in-wheel motors 20 provided in the wheels 11, 13 on the turning inner side from exceeding the upper limit of the control range. Thus, with the vehicle control apparatus, it is possible to reliably execute the vehicle motion control at the time of braking of the vehicle 1, thereby efficiently executing the regeneration-friction cooperative brake control and the vehicle motion control at the same time.

Next, a second embodiment will be described. As described above, in a case where a regenerative braking force or a driving force is generated in each of the wheels 11, 12, 13, 14 by the corresponding in-wheel motor 20 when the vehicle 1 is turning to the left in FIG. 3, a downward force acts on the front wheel 11, an upward force acts on the front wheel 12, a downward force acts on the rear wheel 13, and an upward force acts on the rear wheel 14, but the magnitudes of the forces respectively acting on the wheels 11, 12, 13, 14 differ from each other.

For example, when the same magnitude of regenerative braking force (or driving force) is generated in each of the wheels 11, 12, 13, 14 by the corresponding in-wheel motor 20, a vertical force acting on each of the front wheels 11, 12 is smaller than a vertical force acting on each of the rear wheels 13, 14. In other words, the conversion efficiency at which each of the front wheels 11, 12 converts the regenerative braking force (or driving force) into the vertical force is lower than the conversion efficiency at which each of the rear wheels 13, 14 converts the regenerative braking force (or driving force) into the vertical force. Note that, such a difference in the conversion efficiency of the vertical force between the front wheels and the rear wheels occurs due to the fact that the instantaneous rotation angle of each of the suspension mechanisms 40 on the front wheels 11, 12 side is smaller than the instantaneous rotation angle of each of the suspension mechanisms 40 on the rear wheels 13, 14 side. Note that, “instantaneous rotation angle” indicates an angle between a straight line connecting the instantaneous center of rotation of each suspension mechanism 40 to the ground-contacting point of a corresponding one of the wheels 11, 12, 13, 14 and a road surface (wheel-contacting horizontal surface).

In view of this, in the vehicle motion control, in order to achieve a balance between the two roll moments, that is, the roll moment generated on the front wheels 11, 12 side and the roll moment generated on the rear wheels 13, 14 side, the regenerative braking force (or driving force) generated in each of the front wheels 11, 12 by the corresponding in-wheel motor 20 needs to be greater than the regenerative braking force (or driving force) generated in each of the rear wheels 13, 14 by the corresponding in-wheel motor 20. Thus, the used motor force of the in-wheel motor 20 of the front wheel 11 on the turning inner side, among the wheels 11, 12, 13, 14, is most likely to exceed the upper limit of the control range for the in-wheel motor 20.

Thus, in the control executed by the vehicle control apparatus according to the present embodiment, in step S6 in FIG. 4 described above, the braking force ratio changing unit 74 decreases only the ratio of the regenerative braking force to the required braking force to be applied to the front wheel 11 on the turning inner side, regarding the ratio between the regenerative braking force and the frictional braking force in the required braking force to be applied to each of the wheels 11, 13 on the turning inner side, which is calculated by the braking force ratio calculation unit 72.

Thus, the vehicle control apparatus according to the present embodiment decreases the ratio of the regenerative braking force to the required braking force to be applied to the front wheel 11 on the turning inner side, in which the used motor force of the in-wheel motor 20 is most likely to exceed the upper limit of the control range for the in-wheel motor 20, regarding the ratio between the regenerative braking force and the frictional braking force in the required braking force, which is calculated by the braking force ratio calculation unit 72. In this way, it is possible to prevent the used motor force of the in-wheel motor 20 from exceeding the upper limit of the control range for the in-wheel motor 20.

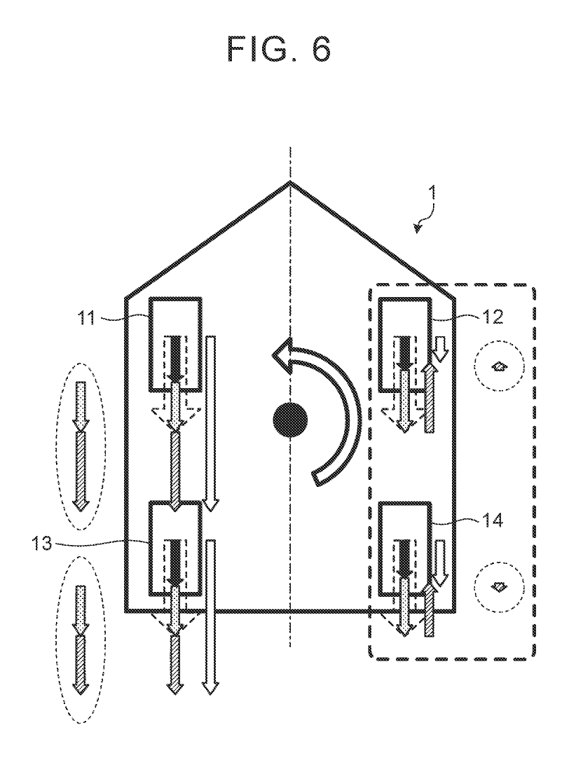

Next, a third embodiment of the disclosure will be described. In the control executed by the vehicle control apparatus according to each of the first and second embodiments, the ratio of the regenerative braking force to the required braking force to be applied to each of the wheels 11, 13 on the turning inner side or the ratio of the regenerative braking force to the required braking force to be applied to the front wheel 11 on the turning inner side is decreased, regarding the ratio between the regenerative braking force and the frictional braking force in the required braking force to be applied to each wheel, which is calculated by the braking force ratio calculation unit 72 (see FIG. 3). However, the ratio of the frictional braking force to the required braking force to be applied to each of the wheels 12, 14 on the turning outer side or the ratio of the frictional braking force to the required braking force to be applied to the front wheel 12 on the turning outer side may be decreased, as illustrated in FIG. 6.

When the regeneration-friction cooperative brake control and the vehicle motion control are executed at the same time, the direction of the regenerative braking force in the regeneration-friction cooperative brake control and the direction of the driving force corresponding to the motoring control force in the vehicle motion control are opposite to each other on the turning outer side. Thus, the regenerative braking force and the driving force cancel out each other, and the used motor force becomes small as a whole, as described above. Therefore, there is room in the control range for the in-wheel motor 20. Thus, the used motor force is less likely to exceed the upper limit of the control range, even when the ratio of the frictional braking force to the required braking force to be applied to each of the wheels 12, 14 on the turning outer side is decreased and the ratio of the regenerative braking force to the required braking force to be applied to each of the wheels 12, 14 is increased by an amount corresponding to a decrease in the frictional braking force.

Thus, in the control executed by the vehicle control apparatus according to the present embodiment, as illustrated in FIG. 6, in step S6 in FIG. 4 described above, the braking force ratio changing unit 74 decreases the ratio of the frictional braking force to the required braking force to be applied to each of the wheels 12, 14 on the turning outer side or the ratio of the frictional braking force to the required braking force to be applied to the front wheel 12 on turning outer side, and increases the regenerative braking force to the required braking force to be applied to each of the wheels 12, 14 or the ratio of the regenerative braking force to the required braking force to be applied to the front wheel 12, regarding the ratio between the regenerative braking force and the frictional braking force in the required braking force to be applied to each wheel, which is calculated by the braking force ratio calculation unit 72 (see FIG. 3).

In this way, the vehicle control apparatus according to the present embodiment can increase the regenerative braking force applied to each of the wheels 12, 14 (or the front wheel 12) on the turning outer side and decrease the frictional braking force applied to each of the wheels 12, 14 (or the front wheel 12). Thus, it is possible to increase the amount of electric power to be charged into the battery 50 and reduce a frictional loss.

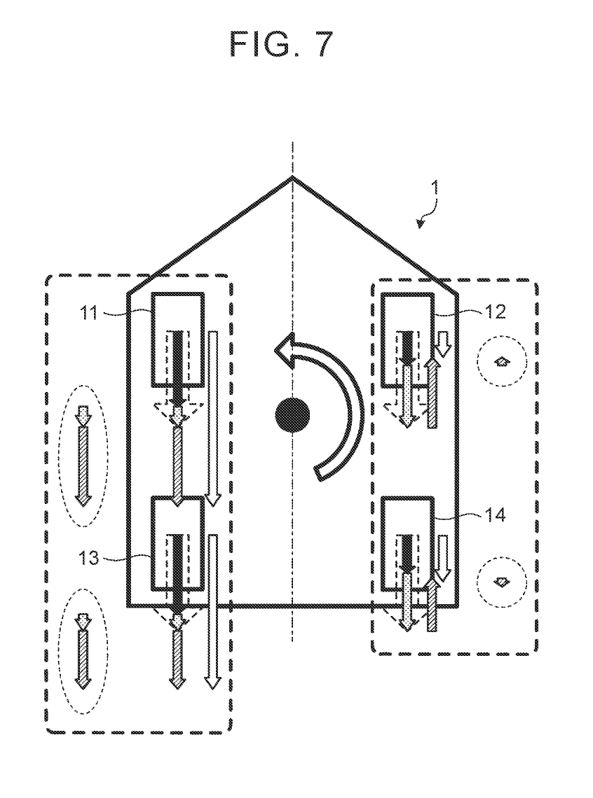

Next, a fourth embodiment will be described. In the control executed by the vehicle control apparatus according to each of the first to third embodiments described above, the ratio between the regenerative braking force and the frictional braking force in the required braking force is changed for at least one of the wheels 11, 13 on the turning inner side, or the ratio between the regenerative braking force and the frictional braking force in the required braking force is changed for at least one of the wheels 12, 14 on the turning outer side. Alternatively, the ratio between the regenerative braking force and the frictional braking force in the required braking force may be changed for each of all the wheels 11, 12, 13, 14, as illustrated in FIG. 7.

In the vehicle control apparatus according to the present embodiment, in step S6 in FIG. 4 described above, the braking force ratio changing unit 74 decreases the ratio of the regenerative braking force to the required braking force to be applied to each of the wheels 11, 13 (or the front wheel 11) on the turning inner side, regarding the ratio between the regenerative braking force and the frictional braking force in the required braking force to be applied to the wheels 11, 13 on the turning inner side, which is calculated by the braking force ratio calculation unit 72 (see FIG. 3), as illustrated in FIG. 7. Further, the braking force ratio changing unit 74 decreases the ratio of the frictional braking force to the required braking force to be applied to each of the wheels 12, 14 on the turning outer side, regarding the ratio between the regenerative braking force and the frictional braking force in the required braking force to be applied to the wheels 12, 14 on the turning outer side, which is calculated by the braking force ratio calculation unit 72 (see FIG. 3).

Thus, the vehicle control apparatus according to the present embodiment decreases the ratio of the regenerative braking force to the required braking force to be applied to each of the wheels 11, 13 (or the front wheel 11) on the turning inner side, in which the used motor force is likely to exceed the upper limit of the control range for the in-wheel motor 20, regarding the ratio between the regenerative braking force and the frictional braking force in the required braking force to be applied to each of the wheels 11, 13, which is calculated by the braking force ratio calculation unit 72. In this way, it is possible to prevent the used motor force of the in-wheel motor 20 from exceeding the upper limit of the control range for the in-wheel motor 20. Further, it is possible to increase the regenerative electric power on the turning outer side by increasing the regenerative braking force on the turning outer side, by an amount corresponding to a decrease in the regenerative electric power due to a decrease in the regenerative braking force on the turning inner side.

Next, a fifth embodiment will be described. The control is executed by the vehicle control apparatus according to each of the first to fourth embodiments, on the precondition that the vehicle motion control is executed while the vehicle 1 is making a turn. However, the vehicle 1 need not be making a turn. That is, the vehicle motion control may be executed not only when the vehicle 1 is making a turn, but also when the vehicle 1 is traveling straight ahead. In the case where the vehicle 1 is traveling straight ahead, the vehicle motion control is executed as sprung mass damping control. In this case, control is executed such that the sprung mass of the vehicle 1 is disposed so as to be as horizontal as possible. For example, when there is a disturbance from a road surface, a vertical force for returning a portion moved due to the disturbance to its original state is generated, by generating a regenerative braking force or a driving force in each of the wheels 11, 12, 13, 14.

In the control executed by the vehicle control apparatus according to the present embodiment, in step S5 in FIG. 4 described above, the braking force ratio changing unit 74 uses a friction-regeneration braking ratio changing condition that is different from that used in each of the first to fourth embodiments. That is, the friction-regeneration braking ratio changing condition in the present embodiment is satisfied when a braking operation is performed by the driver and a resultant force (refer to each dashed circle in FIG. 3) of a regenerative braking force based on the friction-regeneration braking ratio and a regenerative braking force corresponding to a regenerative control force in the vehicle motion control exceeds the upper limit of the control range for the in-wheel motor 20, in any one of the wheels 11, 12, 13, 14.

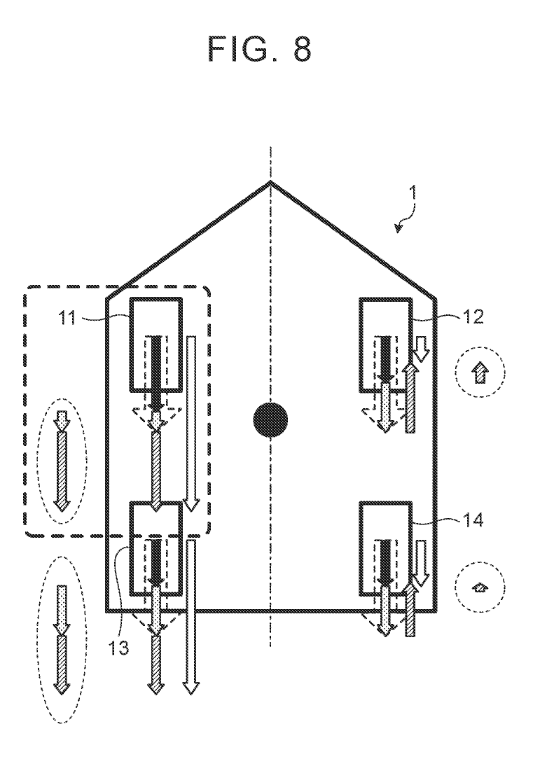

As illustrated in FIG. 8, in step S6 in FIG. 4 described above, the braking force ratio changing unit 74 decreases the ratio of the regenerative braking force to the required braking force and increases the ratio of the frictional braking force to the required braking force, regarding the ratio between the regenerative braking force and the frictional braking force in the braking force to be applied to the wheel 11 with the in-wheel motor 20 in which the used motor force (the resultant force) exceeds the upper limit of the control range.

Thus, the vehicle control apparatus according to the present embodiment can prevent the used motor force of the in-wheel motor 20 from exceeding the upper limit of the control range, by decreasing the ratio of the regenerative braking force to the required braking force, regarding the ratio between the regenerative braking force and the frictional braking force in the required braking force, which is calculated by the braking force ratio calculation unit 72, for the wheel (the wheel 11 in FIG. 8) in which the used motor force exceeds the control range for the in-wheel motor 20.

Next, a sixth embodiment will be described. In the fifth embodiment, the condition that a braking operation is performed by the driver and the used motor force of the in-wheel motor 20 exceeds the upper limit of the control range is used as the friction-regeneration braking ratio changing condition. However, the friction-regeneration braking ratio changing condition is not limited to this.

The friction-regeneration braking ratio changing condition in the present embodiment is satisfied when a braking operation is performed by the driver and a resultant force (refer to each dashed circle in FIG. 3) of a regenerative braking force based on the friction-regeneration braking ratio and a regenerative braking force corresponding to a regenerative control force in the vehicle motion control falls below the required electric power that is required by the battery 50 (see FIG. 1), in any one of the wheels 11, 12, 13, 14.

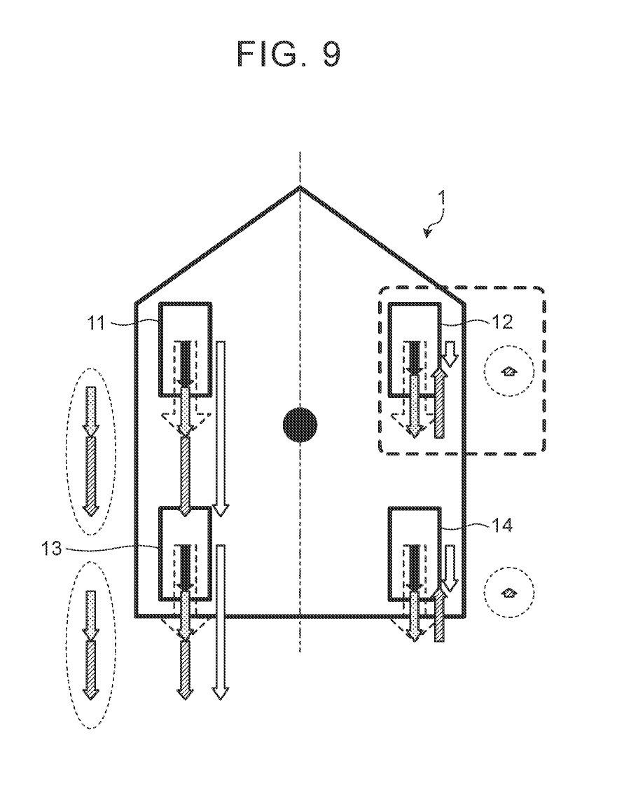

Then, as illustrated in FIG. 9, in step S6 in FIG. 4 as described above, the braking force ratio changing unit 74 decreases the ratio of the frictional braking force to the required braking force and increases the ratio of the regenerative braking force to the required braking force, regarding the ratio between the regenerative braking force and the frictional braking force in the required braking force to be applied to the wheel 12 with the in-wheel motor 20 in which the regenerative braking force falls below the electric power required by the battery 50.

Thus, the vehicle control apparatus according to the present embodiment can increase the regenerative electric power obtained by using the in-wheel motor 20, thereby obtaining the required electric power required by the battery 50.

While the vehicle control apparatus according to the embodiments of the disclosure has been described above, the embodiments of the disclosure that have been described in the specification are to be considered in all respects as illustrative and not restrictive. The technical scope of the disclosure is defined by claims, and all changes which come within the meaning and range of equivalency of the claims are therefore intended to be embraced therein.

For example, in the control executed by the vehicle control apparatus according to each of the first and second embodiments, the ratio of the regenerative braking force to the required braking force to be applied to each of the wheels 11, 13 (or the front wheel 11) on the turning inner side is decreased, regarding the ratio between the regenerative braking force and the frictional braking force in the required braking force, which is calculated by the braking force ratio calculation unit 72 (see FIG. 3). Alternatively, the ratio of the regenerative braking force to the required braking force to be applied to each of the wheels 11, 13 (or the front wheel 11) on the turning inner side may be set to zero. That is, the braking force ratio changing unit 74 may change the ratio between the regenerative braking force and the frictional braking force in the required braking force to be applied to each of the wheels 11, 13 (or front wheel 11) on the turning inner side, such that there is only frictional braking force.

Thus, the vehicle control apparatus sets, to zero, the ratio of the regenerative braking force to the required braking force to be applied to each of the wheels 11, 13 (or the front wheel 11) on the turning inner side, in which the used motor force is likely to exceed the upper limit of the control range for the in-wheel motor 20, regarding the ratio between the regenerative braking force and the frictional braking force in the required braking force, which is calculated by the braking force ratio calculation unit 72. In this way, it is possible to reliably prevent the used motor force of the in-wheel motor 20 from exceeding the upper limit of the control range for the in-wheel motor 20.

In the control executed by the vehicle control apparatus according to the third embodiment, the ratio of the frictional braking force to the required braking force to be applied to each of the wheels 12, 14 (or the front wheel 12) on the turning outer side is decreased, regarding the ratio between the regenerative braking force and the frictional braking force in required braking force, which is calculated by the braking force ratio calculation unit 72 (see FIG. 3). Alternatively, the ratio of the frictional braking force to the required braking force to be applied to each of the wheels 12, 14 (or front wheel 12) on the turning outer side may be set to zero. That is, the braking force ratio changing unit 74 may change the ratio between the regenerative braking force and the frictional braking force in the required braking force to be applied to each of the wheels 12, 14 (or front wheel 12) on the turning outer side, such that there is only regenerative braking force.

Thus, the vehicle control apparatus can significantly increase the regenerative braking force to be applied to each of the wheels 12, 14 (or the front wheel 12) on the turning outer side and significantly decrease the frictional braking force to be applied to each of the wheels 12, 14 (or the front wheel 12) on the turning outer side. Thus, it is possible to significantly increase the regenerative electric power and to significantly reduce the frictional loss.

Further, in the vehicle control apparatus according to each of the first and fourth embodiments, when the regenerative braking force to be applied to each of the wheels 11, 13 on the turning inner side is decreased, the braking force ratio changing unit 74 may set a rate or amount of a change in the ratio for the front wheel 11 on the turning inner side to be greater than that for the rear wheel 13 on the turning inner side. “Set an amount of change in the ratio for the front wheel 11 on the turning inner side to be greater than that for the rear wheel 13 on the turning inner side” indicates, for example, that the ratio between the regenerative braking force and the frictional braking force in the required braking force to be applied to the front wheel 11 on the turning inner side is changed from 5:5 to 2:8, whereas the ratio between the regenerative braking force and the frictional braking force in the required braking force to be applied to the rear wheel 13 on the turning inner side is changed from 5:5 to 3:7.

Thus, the vehicle control apparatus can rapidly and reliably prevent the used motor force of the in-wheel motor 20 from exceeding the upper limit of the control range, by increasing the rate or amount of change in the ratio of the regenerative braking force in the friction-regeneration braking ratio, for the front wheel 11 on the turning inner side in which the used motor force of the in-wheel motor 20 is most likely to exceed the upper limit of the control range.

Further, in the vehicle control apparatus according to each of the third and fourth embodiments, when the frictional braking force to be applied to each of the wheels 12, 14 on the turning outer side is decreased, the braking force ratio changing unit 74 may set a rate or amount of a change in the ratio for the front wheel 12 on the turning outer side to be greater than that for the rear wheel 14 on the turning outer side.

Thus, the vehicle control apparatus can rapidly and significantly increase the regenerative electric power and rapidly and significantly reduce the frictional loss, by increasing the rate or amount of change in the ratio of the frictional braking force in the friction-regeneration braking ratio, for the front wheel 12 on the turning outer side in which there is plenty of room in the control range for the in-wheel motor 20.

What is claimed is:

1. A vehicle control apparatus comprising:
braking-driving force generation mechanisms provided at respective wheels of a vehicle, each of the braking-driving force generation mechanisms configured to generate a driving force to be applied to a corresponding one of the wheels or a regenerative braking force to be applied to the corresponding one of the wheels;
friction braking mechanisms provided at the respective wheels, each of the friction braking mechanisms configured to apply a frictional braking force to a corresponding one of the wheels; and
a controller configured to control the braking-driving force generation mechanisms and the friction braking mechanisms, wherein
the controller is configured to:
calculate a required braking force;
calculate a ratio between the regenerative braking force and the frictional braking force in the required braking force to be applied to each of the wheels, based on the required braking force;
calculate a vehicle motion control force for causing each of the braking-driving force generation mechanisms to generate the driving force or the regenerative braking force, the vehicle motion control force being a control force for executing vehicle motion control for controlling a motion of the vehicle; and
change the ratio between the regenerative braking force and the frictional braking force, in a specific wheel among the wheels, such that the ratio in the specific wheel differs from the ratio between the regenerative braking force and the frictional braking force in each of the other wheels, when a command to generate the require braking force is issued and the vehicle motion control is executed.

2. The vehicle control apparatus according to claim 1, wherein the controller is configured to decrease the ratio of the regenerative braking force to the required braking force to be applied to at least one of the wheels on a turning inner side when the vehicle is making a turn.

3. The vehicle control apparatus according to claim 2, wherein the controller is configured to make a rate or amount of a change in the ratio for the front wheel on the turning inner side greater than a rate or amount of a change in the ratio for the rear wheel on the turning inner side when decreasing the ratio of the regenerative braking force to the required braking force to be applied to at least one of the wheels on the turning inner side.

4. The vehicle control apparatus according to claim 1, wherein the controller is configured to decrease the ratio of the frictional braking force to the required braking force to be applied to at least one of the wheels on a turning outer side when the vehicle is making a turn.

5. The vehicle control apparatus according to claim 4, wherein the controller is configured to make a rate or amount of a change in the ratio for the front wheel on the turning outer side greater than a rate or amount of a change in the ratio for the rear wheel on the turning outer side when decreasing the ratio of the frictional braking force to the required braking force to be applied to at least one of the wheels on the turning outer side.

6. The vehicle control apparatus according to claim 1, wherein the controller is configured to calculate the required braking force based on a braking operation performed by a driver.

7. The vehicle control apparatus according to claim 1, wherein each of the braking-driving force generation mechanisms generates the driving force to be applied to a corresponding one of the wheels or the regenerative braking force to be applied to the corresponding one of the wheels, independently from the braking-driving force generation mechanisms of the other wheels.

8. The vehicle control apparatus according to claim 1, wherein each of the braking-driving force generation mechanisms is a motor that generates the driving force to be applied to a corresponding one of the wheels or the regenerative braking force to be applied to the corresponding one of the wheels.
